(19) United States
(12) Patent Application Publication
(10) Pub. No.: US 2020/0122646 A1
(43) Pub. Date: Apr. 23, 2020

(54) TRACTOR CADDY

(71) Applicant: RICHARD N. PELLEGRINO, Hot Springs, AR (US)

(72) Inventor: RICHARD N. PELLEGRINO, Hot Springs, AR (US)

(21) Appl. No.: 16/167,473

(22) Filed: Oct. 22, 2018

(51) Int. Cl. B60R 11/06; B60R 9/06; F16M 11/32

(52) U.S. Cl. CPC B60R 11/06; B60R 2011/004; F16M 11/32; B60R 9/06

(57) ABSTRACT

Apparatus for transporting tools and implements. The apparatus is removably mounted on an agricultural prime mover, such as a tractor. The apparatus is secured to the tractor by a mounting structure secured to the front end of the tractor, and a support device that removably engages the mounting structure. The primary portion of the disclosure is a transport basket. This element includes a bottom a bottom and sides. The bottom is oriented generally parallel with the ground, having openings dimensioned to allow materials such as dirt and mud to be shed. Two lateral sides are oriented vertically, parallel with the tractor's longitudinal axis, both sides removably mounted on the bottom. Each lateral side includes means for manually lifting the transport basket and means for supporting the transport basket when the transport basket is disengaged from the tractor. A front side is oriented vertically and transverse to the mover's longitudinal axis.

### BACKGROUND

The present disclosure relates to a tractor caddy, a device mounted on the front end of a tractor for carrying tools from a storage area to a work site. Often, a work project requires not only a tractor but a number of other took as well. Assembling a pile of cut logs and hauling them to a destination, for example, requires not only the tractor (for moving, stacking, and hauling logs), but also a number of other tools, such as chain saws and associated support equipment, axes, and the like. Carrying such tools from the start point, such as a barn or central equipment shed, to the work site, can easily tax the capabilities of the work crew, resulting in lost time and effort.

The primary solution to this problem offered by the prior art has been a platform or carrier mounted at the rear end of the tractor. In many applications, the platform or basket is attached to the tractor's power takeoff (PTO), allowing it to be raised and lowered for loading or unloading tools. Of course, occupying the PTO with the carrier prevents the use of other PTO devices that could be necessary to the task at hand. For example, for the log moving example noted above, a lifting or grabbing device could be required for assembling a pile of logs and then for moving the pile. Thus, for the most widely offered solution, the prior art demands that the user choose between carrying required tools and employing required devices. Clearly, those offerings fall short of solving the problem.

Recognizing the shortfall inherent in proffered devices, the art has attempted to close the existing gap. Generally, attempts to provide a front-mounted carrier device have produced devices that fall short of solving the existing problem. Most generally, the devices in question have proved difficult to use, inflexible in application to, and not responsive to actual requirements. For example, devices generally are tailored to specific, narrowly drawn requirements. Small box-like structures are the most prevalent, which allow the transport of a few hand tools, but which are not suitable for large devices such as chain saws or long devices such as shovels, rakes, and similar tools. Other devices are restricted to a given construction. A box with solid walls works well for loose items but not for irregularly shaped devices, or muddy tools where the ability to shed dirt, mud, and moisture would be highly desired. A flexible, easily used device thus remains out of reach for those seeking a useful tractor caddy. Other useful features not available in the existing prior art include a capability for drive on/drive off operation, coupled with sizing that permits easy handling by one or two persons.

### SUMMARY

One aspect of the present disclosure is an apparatus for transporting tools and implements, the apparatus being removably mounted on an agricultural prime mover, such as a tractor. The apparatus is secured to the tractor by two elements, a mounting structure secured to the front end of the tractor, and a support device that removably engages the mounting structure. The primary portion of the disclosure is a transport basket. This element generally includes a bottom a bottom and sides. The bottom is oriented generally parallel with the earth's surface, having openings dimensioned to allow materials such as dirt and mud to be shed. Two lateral sides are oriented vertically, parallel with the tractor's longitudinal axis, both sides removably mounted on the bottom. Each lateral side includes means for manually lifting the transport basket and means for supporting the transport basket when the transport basket is disengaged from the tractor. A front side is oriented vertically and transverse to the mover's longitudinal axis.

### BRIEF DESCRIPTION OF THE DRAWINGS

FIG. 1 is a plan view of an embodiment of the present disclosure.

FIG. 2 is a side view of the embodiment of the disclosure shown in FIG. 1.

FIG. 3 is a perspective view of a further embodiment of the present disclosure.

### DETAILED DESCRIPTION

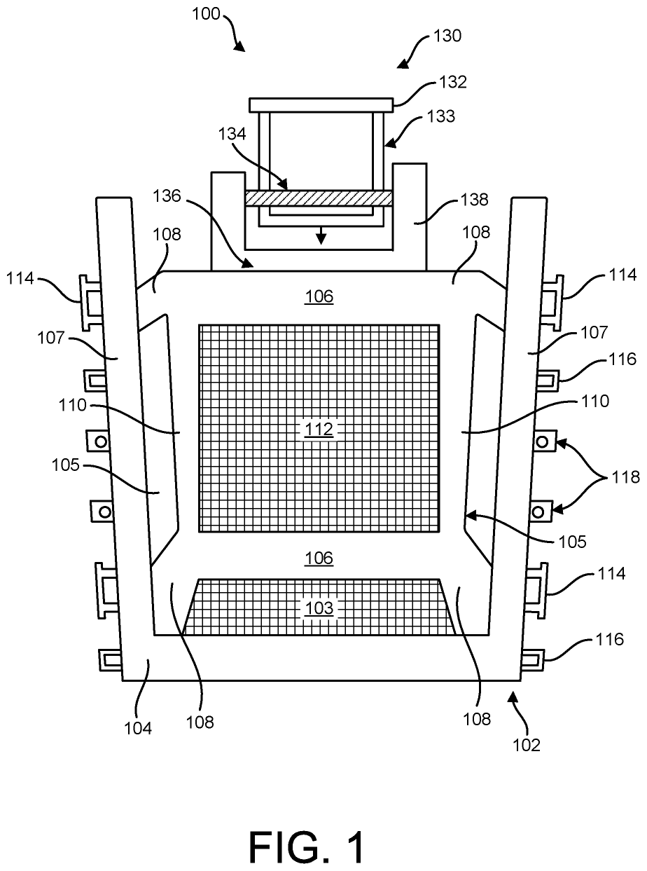

As seen in FIGS. 1 (plan view) and 2 (side view), the tractor caddy 100 of the present disclosure can be described as a basket-like device detachably attached to the front end of a prime mover, such as an agricultural tractor 101 In general, the basket-like device includes three sides, one positioned on the front of the device and two on the basket's lateral sides, leaving one vertical side open. As used herein, device orientations will be consonant with the orientation of the tractor upon which the basket can be mounted. Thus, the noted front vertical side lies on the end of the device remote from the tractor, while the open vertical side lies adjacent to the tractor. The two lateral vertical sides are parallel with the longitudinal axis of the tractor. The basket orientation details are clearly shown in FIG. 1.

As used herein, the term “side” refers to a vertical peripheral boundary of the basket-like device, while the top and bottom are horizontal. Device orientations will be consonant with the orientation of the tractor upon which the basket can be mounted. Thus, the noted front side lies on the end of the device remote from the tractor, while the open side is adjacent to the tractor.

The tractor 101 can be any of the wide variety of commonly employed and widely available agricultural tractors. This element is well known in the art and is therefore represented only generically in the drawings. Those of skill in the art will understand the scope of this element and be able to select or adapt a particular device.

FIG. 1 illustrates a tractor caddy 100 embodying the present disclosure. Broadly, the caddy includes a basket 102 and a mounting assembly 130. The basket includes a front side 103 and two lateral sides 105, both of which are closed, as is bottom 112. That construction leaves the top and rear sides of the basket 102 open. The illustrated embodiment is constructed by joining two transverse elements 106 and two longitudinal elements 110 to form a generally square bottom 112. Upright elements 108, extend upward from the four corners of the square bottom 112. The upper edges of the front and lateral sides are formed by upper longitudinal elements 107 and upper transverse element 104. As illustrated, longitudinal elements 107 may extend rearward beyond the ends of lateral sides 105, which allows for improved capacity for carrying tools, as explained further below.

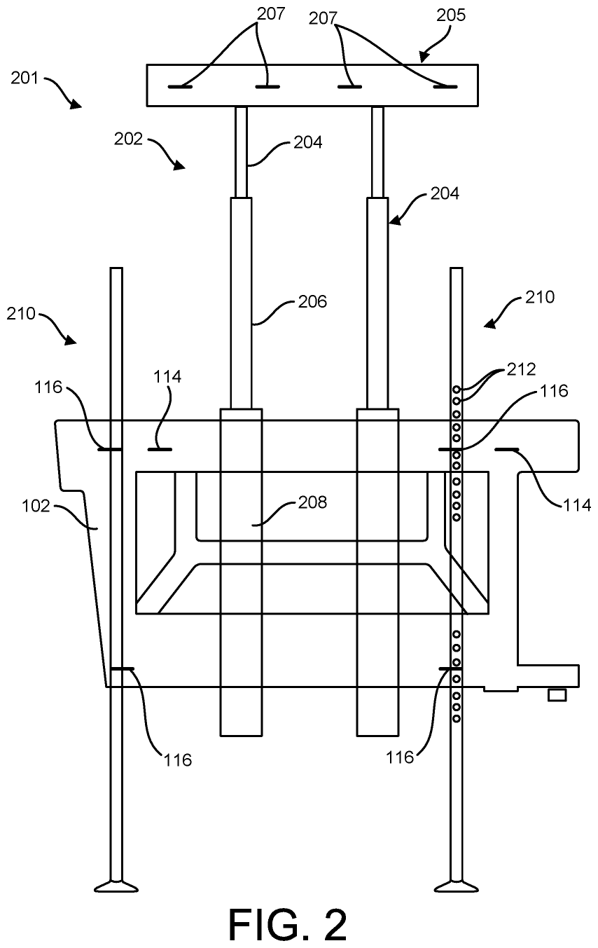

A preferred construction is shown in FIGS. 1 and 2. There, the structural elements 104, 106, 107, 108, and 110, are preferably steel angle stock, preferably fabricated from ¼ steel stock. These elements are preferably welded, though other joining techniques could be employed. Steel material was selected for the combination of strength and weight, though other materials could be employed. If the loads generally involved in the anticipated tasks are relatively light, for example, aluminum elements could be usefully substituted at a greatly reduced weight.

The illustrated design provides several operational advantages over the prior art. First, the fact that the basket 100 includes two lateral sides 105 and a front side 103 ensures that one can access the tractor engine for any required repairs or maintenance without removing the basket. It will be understood that even though mounting and dismounting the basket 100 is made as convenient as possible, it will be advantageous to be able to take steps to access the tractor engine rapidly. Additionally, the fact that basket 100 projects forward from the tractor front and allows the combined unit to navigate through brush more readily than can the tractor on its own. The ability to detect potential obstacles in advance of the tractor wheels, for example, provides for operation that can be both faster and safer than operating without such a forward-projecting device.

It is well known in the tractor design art that many tractors employ weights, removably mounted at the front end of the tractor, to provide stability, particularly on uneven ground. Such weights are most often provided in the form of a number of plates. The tractor caddy 100 described here allows the user to achieve the advantages of such plates, while also providing the advantageous functionality described below. Those of skill in the art will understand how to choose materials, dimensions, and the like to provide a balancing force on the front of the tractor equivalent to that found from conventional plates.

Given that the tools loaded on and off the basket are often dirty or muddy, it has been found advantageous to provide a mechanism allowing dirt to be shed from tools without accumulating in the basket. A preferred method for accomplishing that goal is the provision of mesh panels 112 filling the space enclosed by the structural elements 104, 106, 107, 108, and 110. That design reduces the overall weight of the basket while allowing dirt, mud, or other material to fall out of the basket during transport. Mesh panels 112 can be formed from wire or expanded metal material, with a ratio of open to solid space as desired. Materials such as Kevlar mesh could be suitable for certain applications where cost is not a factor. Those of skill in the art will understand how to provide sufficient opening area to allow material such as dirt and mud to be efficiently shed. Similarly, materials are likely to be developed that those in the art will recognize as desirable to substitute for those suggested here. In addition, the mesh panels 112 can be removable or permanently installed. Removable panels are fitted with fasteners suitable for the task, as will be understood by those in the art.

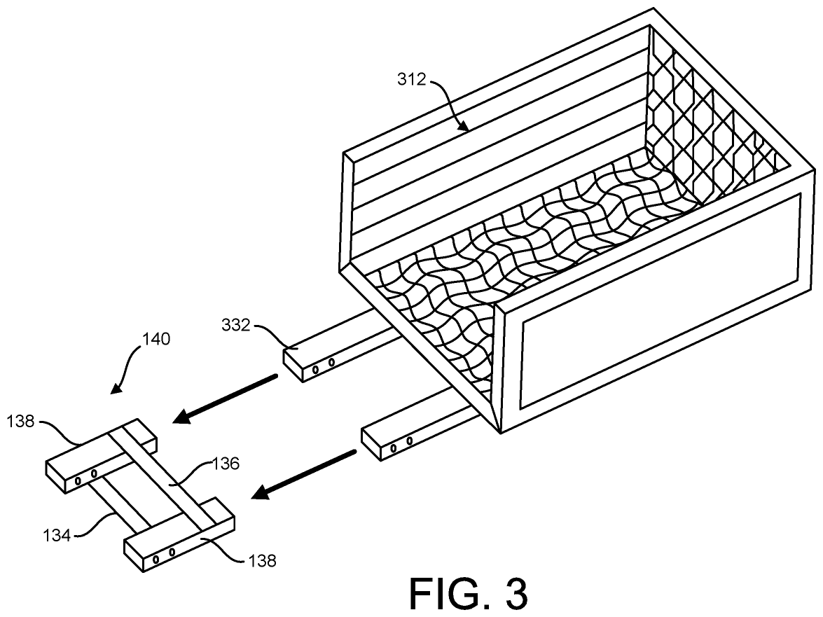

Tasks might arise, however, where a closed bottom or side could be desired. That need can be met by providing a removable solid panel 312, as shown in FIG. 3. Such panels can be formed from lightweight material such as plywood, fitted with suitable fasteners for retaining the panel in position. Those of skill in the art will recognize any need to provide stiffening members, and those persons will have sufficient skills to provide any stiffening required.

In addition to providing a space for carrying tools, the present disclosure offers a number of features that allow one to match transport capabilities with requirements that often arise in the course of a workday. The features described below can best be appreciated in conjunction with the illustrations of FIGS. 1 and 2, taken together. A number of attachment devices is shown in FIG. 1, and FIG. 2 illustrates those devices in use, together with ancillary equipment.

At each end of upper longitudinal elements 107, two handles 114 are provided for manually lifting the tractor caddy. The handles are appropriately sized to facilitate lifting, and they are also appropriately spaced for either two-person or four-person lifting and movement of the tractor caddy. Adjacent each handle 114 is a slide mount 116, with two additional slide mounts 116 carried on each lower longitudinal element 110, each lower slide mount being positioned vertically below the corresponding slide mount on the upper longitudinal element 107. Each slide mount has a slot or bore formed through it, adapted to slidingly receive a support rod 210. As seen in FIG. 2, each support rod 210 has two sets of support apertures 212 formed through it and positioned such that pins (not shown) inserted through selected apertures can support the tractor caddy 100 at a convenient height above ground level. This feature provides a drive in-drive out capability convenient for hobby farmers, small-scale operations, and individuals who operate with one or two persons, rather than an entire work crew. Designing and employing the apertures, pins, and slide mounts to raise the tractor caddy as desired is well within the skill of those in the art and need not be set out in additional detail. A footing device at the lower end of each support rod can provide additional stability to the tractor caddy by increasing the footprint of each support rod.

Additionally, two telescoping rack mounts 118 are carried on each longitudinal element 107, 110, generally centered with respect to the tractor caddy 100. Mounts 118 on the lower longitudinal elements 110 are vertically aligned with those carried on the upper longitudinal elements 107. Each such pair of mounts 118 supports and secures a telescoping tool rack 201, a device capable of securing a variety of different tools for transport to a work site. Each telescoping tool rack 201 includes two telescoping rods 202, devices known in the art. Each telescoping rod includes several sections, such as sections 204, 206, and 208, which slidably extend and retract between fully retracted and fully extended positions. Two such telescoping rods are carried on each side of the tractor caddy 100, joined by a tool rack 205 mounted at the upper end of each telescoping rod 202. The tool rack 205 includes a set of clips 207, so that long-handled tools, such as shovels, rakes, hoes, and the like, can be securely carried to and from a work site. The adjustability of the telescoping tool rack allows it to accommodate a wide variety of tools. The clips can be mechanical devices, such as clevis hangers or the like, or cords for tying a tool in place, or a small bungee cord. These and similar devices will serve to prevent tools from falling out of the basket during transport over rough ground.

The mechanism for attaching the tractor caddy 100 to the front end of a tractor can best be seen in FIGS. 1 and 3. Two support posts 332 extend rearward toward the tractor from the underside of basket bottom 112. Preferably, these posts extend the length of bottom 112, providing support for the basket, but the degree to which that support is needed can determine the length of support posts 332, as can be determined by one of skill in the mechanical design art.

A receiver assembly 140 engages support posts 332 to prepare the tractor caddy 100 for mounting on a tractor. This assembly includes two attachment sleeves 138, each being adapted to slide over one of the support posts 332. Each attachment sleeve should engage the corresponding support post with a sliding or close sliding fit, providing ready mounting without excessive play between the components. Pins or other known attachment means are employed to removably attached each attachment sleeve to the corresponding support post. Upper and lower crosspieces 134 and 136 join the two attachment sleeves 138, these elements being strongly affixed by known methods such as welding. A top view of the receiver assembly in position over the support posts is provided in FIG. 1, showing the resulting assembly as generally U-shaped, with the upper crosspiece 136 being positioned adjacent to or against the transverse element 106.

The tractor caddy is mounted on a tractor by employing a universal adaptor 130. This device includes a U-shaped bracket 133 and a mounting bracket 132. The U-shaped bracket 133 is dimensioned to slide into the slot formed in the receiver assembly 140 by the inner sides of the two attachment sleeves 138 and the crosspieces 136 and 134. The bracket 133 is then attached to the attachment sleeves by conventional means, such as bolts. The universal adaptor's mounting bracket 132 bolts to an attachment plate (not shown) found at the front end of practically all modern tractors.

The design of universal adapter 130 allows it to be retained on the tractor even after the basket 100 is removed. If it is desired to employ weights at the front end of the tractor, such weights can be easily attached to universal adapter 130, as will be apparent to those of skill in the art.

It will thus be seen that the present disclosure sets out a device that will allow groups of tools and supplies easily to be transported to a work site. This device will find particular application in the large numbers of relatively small-scale agricultural operations. The prior art would require provision of hydraulically operated support devices in order to obtain functionality equivalent to what is presented here. That expense would be particularly onerous to a single-family or equivalent size farm. The present disclosure offers high functionality at exceeding low cost.

I claim:

1. Apparatus for transporting tools and implements, the apparatus being removably mounted on an agricultural prime mover, comprising:
a mounting structure secured to the front end of the prime mover;
a support device, adapted to removably engage the mounting structure; and
a transport basket, including
attachment means for engaging the support device;
a bottom, oriented generally parallel with the earth's surface, having openings dimensioned to allow materials such as dirt and mud to be shed;
two lateral sides, oriented vertically and parallel with the mover's longitudinal axis, both sides removably mounted on the bottom, with each lateral side including
means for manually lifting the transport basket; and
means for supporting the transport basket when the transport basket is disengaged from the prime mover;
and a front side, oriented vertically and transverse to the mover's longitudinal axis, positioned at the end of the basket remote from the prime mover.

2. The transport apparatus of claim 1, wherein the support device includes
a plurality of support posts attached to an underside of the bottom, extending from the bottom toward the prime mover;
an attachment sleeve for each support post, adapted to slide over and engage the support post; and
one or more crosspieces extending between and affixed to the attachment sleeves.

3. The transport apparatus of claim 1, wherein the mounting structure includes
a U-shaped bracket, dimensioned to slide into a slot formed by two attachment sleeves; and
a mounting plate, adapted for attachment to the prime mover.

4. The transport apparatus of claim 1, wherein the means for manually lifting the transport basket includes one or more handles, dimensioned and positioned for lifting and movement by two persons.

5. The transport apparatus of claim 1, wherein the means for manually lifting the transport basket includes one or more handles, dimensioned and positioned for lifting and movement by four persons.

6. The transport apparatus of claim 1, wherein the means for means for supporting the transport basket includes
two pairs of slide mounts affixed to each lateral slide, each mount having an aperture formed therein;
a support rod provided for each mount, adapted for sliding movement in each mount aperture, having pin apertures formed therein for stable support of the basket; and
pins adapted to be received in each support rod pin aperture.

7. The transport apparatus of claim 1, further including one or more telescoping tool racks, adapted for securing tools during transport.

8. The telescoping tool racks of claim 7, particularly adapted for securing long-handled tools, including shovels, rakes, and hoes.
